(19) United States
(12) Patent Application Publication
(10) Pub. No.: US 2008/0309739 A1
(43) Pub. Date: Dec. 18, 2008

(54) FLUID SUPPLYING APPARATUS, FLUID EJECTING APPARATUS, AND FLUID SUPPLYING METHOD

(75) Inventor: Nobuhito TAKAHASHI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/139,334

(22) Filed: Jun. 13, 2008

(30) Foreign Application Priority Data
Jun. 14, 2007 (JP) 2007-157657
Apr. 14, 2008 (JP) 2008-104820

(51) Int. Cl. B41J 2/175

(52) U.S. Cl. 347/85

(57) ABSTRACT

The invention provides a liquid supplying apparatus that is attached to a liquid ejecting apparatus for supplying liquid to a plurality of liquid ejecting heads of the liquid ejecting apparatus. The liquid supplying apparatus includes: at least one liquid container and a plurality of liquid-supply channels that supply liquid from the least one liquid container to the plurality of liquid ejecting heads by utilizing a difference in the water head difference therebetween. The liquid-supply channels are connected to the at least one liquid container and corresponding liquid-supply reception ports of the plurality of liquid ejecting heads, wherein the number of the liquid-supply reception ports of the liquid ejecting heads is larger than the number of the liquid-supply channels.

### BACKGROUND OF THE INVENTION

The entire disclosure of Japanese Patent Application No. 2007-157657, filed Jun. 14, 2007 and Japanese Patent Application No. 2008-104820, filed Apr. 14, 2008 are expressly incorporated herein by reference.

1. Technical Field

The present invention relates to a fluid or liquid supplying apparatus for a liquid ejecting apparatus and a method for supplying liquid to the liquid ejecting heads of the liquid ejecting apparatus.

2. Related Art

In the technical field to which the present invention pertains, an ink-supply apparatus having a single main ink-supply tube or flow channel with a plurality of individual “branches” or individual ink-supply flow channels is known. An example of such an ink-supply apparatus is disclosed in Japanese Patent No. JP-A-2005-22124 (see FIGS. 2 and 3), wherein a single main ink-supply flow channel extends from a main tank. Each of the individual ink-supply flow channels branch off from the single main ink-supply flow channel. A plurality of liquid ejecting heads are connected to a corresponding individual ink-supply flow channel. The main tank of the ink-supply apparatus disclosed in JP-A-2005-22124 functions as a liquid container. Ink is supplied from the main tank to each of the plurality of unit heads that make up a recording head. Herein, ink is an example of a liquid that may be ejected from a liquid ejecting apparatus. An ink circulation system where ink that has flowed out of the main tank is returned to the main tank is used.

In contrast, many ink-jet printers of the related art adopt a non-circulation ink-supply system wherein ink that flows out of the main tank never returns to the main tank. In such one-way ink-supply systems, ink is supplied from a main tank toward a recording head without flowing back to the main tank.

FIG. 10 is a diagram that schematically illustrates an example of the configuration of an ink-supply apparatus of the related art. As illustrated in FIG. 10, a single ink-supply tube 62 extends from an ink tank 61. The single ink-supply tube 62 is connected to a plurality of recording heads 64. The unit recording heads 64 make up a line head 63. The single ink-supply tube 62 extends along the length of the elongated line head 63 so as to offer a single main ink-supply route for supplying ink to each of the plurality of unit recording heads 64, which comprise the line head 63. The single ink-supply tube 62 has a plurality of branch ink-supply tube portions 62A for each unit recording head 64. Each of these individual ink-supply tube portions 62A branches off from the main ink-supply tube portion of the single ink-supply tube 62. A sub pump is provided on the ink-supply flow channel, which will be hereafter referred to as an ink-supply pump. The ink-supply pump applies pressure for the supplying of ink.

Each of the unit recording heads 64 has a tube-joint portion 64A. The tube-joint portion 64A functions as a liquid-supply reception port. Each of the tube-joint portions 64A of the unit recording heads 64 is connected to a corresponding branch ink-supply tube portion 62A of the single ink-supply tube 62. As previously described, the plurality of individual ink-supply tube portions 62A branch off from the main ink-supply tube portion of the single ink-supply tube 62. Unfortunately, however, when such a single-main ink-supply scheme is adopted, it is relatively difficult for ink to reach the most downstream tube-joint portion 64A of the most downstream unit recording head 64 that is connected to the most downstream branch ink-supply tube portion 62A of the single ink-supply tube 62. It should be noted that the most downstream branch ink-supply tube portion 62A of the single ink-supply tube 62 is provided at the furthest position on the ink-supply route from the ink tank 61. In FIG. 10, the most downstream branch ink-supply tube portion 62A of the single ink-supply tube 62 is shown as the ink-supply tube portion 62A that is furthest toward the left. In order to facilitate the ink to reach the most downstream tube-joint portion 64A of the most downstream unit recording head 64, it is necessary to provide an ink-supply pump somewhere in the ink supply route, in order to increase the pressure downstream from the ink-supply pump. Disadvantageously, however, the raised pressure could cause the disconnection of a tube(s) or even the blowout of a tube. In addition to such a risk, it increases the production cost of the ink-supply apparatus.

In order to avoid the disadvantages described above, some systems supply ink without using any ink-supply pump by utilizing a water head difference between the ink tank 61 and the unit recording heads 64. However, such an alternative ink-supply configuration has the disadvantage of relatively poor ink-supply performance, going back to the original problem of difficulty in effectively supplying ink as described above. More specifically, as the distance of the ink-supply route becomes greater, pressure loss increases, which decreases the pressure of the ink supply. As a result thereof, the ink supply may be uneven in the plurality of the unit recording heads 64. This may result in different amounts ink being ejected from the unit recording heads 64, resulting in deterioration in print quality.

### BRIEF SUMMARY OF THE INVENTION

An advantage of some aspects of the invention is to provide a liquid supplying apparatus that makes it possible to reduce unevenness in the supply of liquid from a liquid container to the liquid-supply reception port of each of liquid ejecting heads in a water-head-difference liquid-supply scheme that utilizes a water head difference for the supplying of liquid. In addition, the invention provides, as an advantage of some aspects thereof, a liquid ejecting apparatus having the liquid ejecting heads to which liquid is supplied from such a liquid supplying apparatus. The invention further provides, as an advantage of some aspects thereof, a liquid supplying method for supplying liquid to the liquid ejecting heads of such a liquid ejecting apparatus.

In order to address the above-identified problem without any limitation thereto, the invention provides, as a first aspect thereof, a liquid supplying apparatus that is attached to a liquid ejecting apparatus for supplying liquid to a plurality of liquid ejecting heads of the liquid ejecting apparatus. The liquid supplying apparatus comprises at least one liquid container capable of containing liquid, and a plurality of liquid-supply channels which are connected to the at least one liquid container and are capable of supplying liquid from the at least one liquid container to the plurality of liquid ejecting heads by utilizing a difference in the water head between the liquid container and plurality of liquid ejecting head, wherein each of the plurality of liquid-supply channels are connected to a plurality of corresponding liquid-supply reception ports of the plurality of liquid ejecting heads and the number of the liquid-supply reception ports of the liquid ejecting heads is larger than the number of the liquid-supply channels.

The second aspect of the invention comprises a liquid ejecting apparatus that includes a plurality of liquid ejecting heads and the liquid supplying apparatus according to the first aspect of the invention described above for supplying liquid to each of the liquid-supply reception ports of the plurality of liquid ejecting heads. A third aspect of the invention comprises method of s supplying liquid from at least one liquid container capable of containing liquid to a plurality of liquid ejecting heads. The liquid supplying method comprises providing a plurality of liquid-supply channels that supplies liquid from the least one liquid container to the plurality of liquid ejecting heads by utilizing the difference in the water head between the at least one liquid container and plurality of liquid ejecting heads, and connecting the one end of the plurality of liquid-supply channels to the at least one liquid container and the other end to a corresponding liquid-supply reception ports of the plurality of liquid ejecting heads, wherein the number of the liquid-supply reception ports of the liquid ejecting heads is larger than the number of the liquid-supply channels in order to supplying liquid from the at least one liquid container to each of the liquid-supply reception ports of the plurality of liquid ejecting heads through the plurality of liquid-supply channels.

According to the aspects of the invention, the number of the liquid-supply reception ports of the liquid ejecting heads is larger than the number of the liquid-supply channels. Therefore, it is possible to reduce the length of the liquid-supply routes from the liquid container(s) to the liquid-supply reception ports of the plurality of liquid ejecting heads. For this reason, it is further possible to reduce inconsistencies in the liquid supplying to the respective liquid-supply reception ports of the plurality of liquid ejecting heads.

### BRIEF DESCRIPTION OF THE DRAWINGS

The invention will be described with reference to the accompanying drawings, wherein like numbers reference like elements.

FIG. 1 is a sectional view illustrating an embodiment of the invention comprising a printer;

FIG. 2 is a perspective view that schematically illustrates the exemplary configuration of an ink-supply apparatus according to an exemplary embodiment of the invention;

FIG. 3 is a bottom view illustrating a part of a exemplary line head as viewed from the nozzle-surface side;

FIG. 4 is a diagram that schematically illustrates the configuration of an ink-supply apparatus according to a variation of an embodiment of the invention;

FIG. 5 is a diagram that schematically illustrates an exemplary configuration of an ink-supply apparatus according to another variation of an embodiment of the invention;

FIG. 6 is a diagram that schematically illustrates the configuration of an exemplary ink-supply apparatus according to another variation of an embodiment of the invention;

FIG. 7 is a diagram that schematically illustrates an exemplary configuration of an ink-supply apparatus according to another variation of embodiments of the invention;

FIG. 8 is a diagram that schematically illustrates an exemplary configuration of an ink-supply apparatus according to another variation of embodiments of the invention;

FIG. 9 is a diagram that schematically illustrates an exemplary configuration of an ink-supply apparatus according to another variation of embodiments of the invention; and

FIG. 10 is a diagram that schematically illustrates an example of the configuration of an ink-supply apparatus of the related art.

### DESCRIPTION OF EXEMPLARY EMBODIMENTS

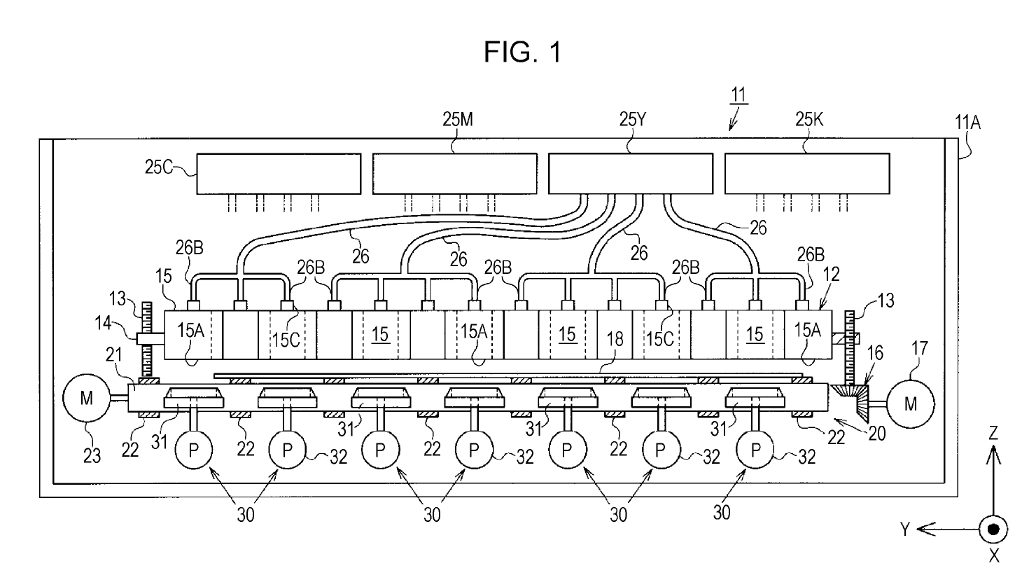

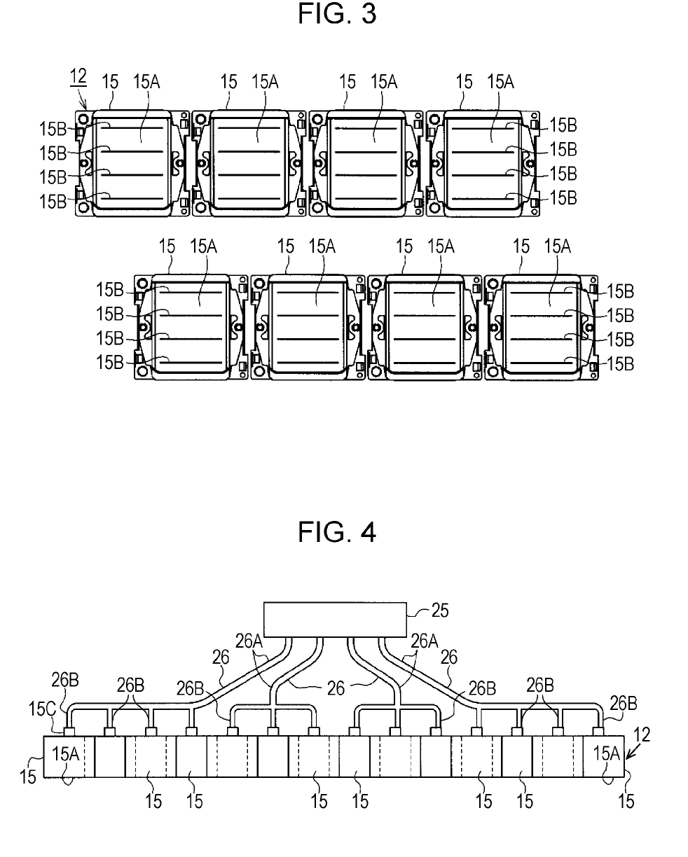

With reference to FIGS. 1-3, an exemplary embodiment of the invention is explained below. FIG. 1 is a sectional view that schematically illustrates the configuration of a non-limiting example of a liquid ejecting apparatus according to an exemplary embodiment of the invention. The ink-jet recording apparatus or liquid ejecting apparatus shown in FIG. 1 is a line printer that is provided with a line head 12. In the following description, the ink-jet recording apparatus is simply referred to as a printer 11. The printer 11 can perform printing by using line head 12 to print on the entire width of a sheet of printing paper having the maximum sheet size. As shown in FIG. 1, the printer 11 has a printer body case 11A that has the shape of an opened box. Four driving shafts 13 are provided inside the printer body case 11A of the printer 11. Each of these four driving shafts 13 stands inside the printer body case 11A, or, in other words, is oriented in a vertical direction inside the printer body case 11A. It should be noted that only two of the four driving shafts 13 are illustrated in FIG. 1. In addition, it should be further noted that the number of the driving shafts 13 is not necessarily limited to four. Each of these four driving shafts 13 comprises a screw shaft. A head-support member 14, which is a supporting frame, has screw holes formed at four corners thereof. Each of these four driving shafts 13 is screw-fixed through a corresponding one of four screw holes of the head-support member 14. Or, in other words, each of these four driving shafts 13 is threadably mounted through the head-support member 14. A plurality of recording heads or unit heads 15 are provided inside the printer body case 11A. In the following description, each of these recording heads is referred to as a “unitary” recording head 15. The head-support member 14 supports the plurality of unitary recording heads 15. As shown in FIG. 3, the plurality of unitary recording heads 15 is arrayed as two lines extending along the width direction of a sheet of printing paper that is orthogonal to the transport direction. Hereafter, the direction of paper transport is referred to as “paper-transport X direction”, whereas the direction of the width of a sheet of printing paper perpendicular to the paper-transport X direction is referred to as “paper-width Y direction”. One of these four driving shafts 13 is in engagement with a gear mechanism 16. An electric motor 17 is connected to the gear mechanism 16. The electric motor 17 supplies motive power to the driving shaft 13 via the gear mechanism 16. As the electric motor 17 rotates in a forward or reverse direction, the line head 12 moves up or down in the Z direction illustrated in FIG. 1.

In the configuration of the printer 11 according to the present embodiment of the invention, a paper-transport unit 20 that transports a sheet of printing paper 18 is provided under the line head 12. The sheet of printing paper 18 is a non-limiting example of a liquid ejection target medium that may be used in association with the invention. The paper-transport unit 20 is made up of, though not necessarily limited thereto, a plurality of paper-transport rollers 21, a plurality of paper-transport belts 22, and an electric motor 23. It should be noted that only one paper-transport roller 21 is shown in FIG. 1. The plurality of paper-transport belts 22 is wound around the plurality of paper-transport rollers 21 at a variety of places as viewed in the axial direction of the paper-transport rollers 21. The electric motor 23 drives the paper-transport roller 21 so as to rotate the paper-transport roller 21. Each of the plurality of paper-transport belts 22 is provided at a position that is not immediately beneath any of the unitary recording heads 15. For example, except the recording head that is furthest left and the recording head that is furthest right shown in FIG. 1, each of the paper-transport belts 22 is provided at a position which corresponds to a gap region between adjacent unitary recording heads 15. Therefore, each of the plurality of paper-transport belts 22 does not face any of the unitary recording heads 15. As the electric motor 23 is driven, the paper-transport rollers 21 rotate. As the paper-transport rollers 21 rotate, the paper-transport belts 22 turn. As a result of the turning of the paper-transport belts 22, a sheet of printing paper 18 that is placed on the paper-transport belts 22 is transported in the paper-transport X direction. As has already been explained above, the line head 12 moves up and down in the Z direction illustrated in FIG. 1 as the electric motor 17 rotates in a forward and reverse direction. By this means, it is possible to adjust the gap between the unitary recording heads 15 and a sheet of printing paper 18. Or, in other words, the upward and downward movement of the line head 12 makes it possible to adjust a clearance between the unitary recording heads 15 and the upper surface of the paper-transport belts 22.

Four ink cartridges 25C, 25M, 25Y, and 25K are arrayed above the line head 12 inside the printer body case 11A of the printer 11. Each of these four ink cartridges contains ink of a corresponding one of four ink colors, that is, cyan (C; 25C), magenta (M; 25M), yellow (Y; 25Y), and black (K; 25K). Each of these four ink cartridges 25C, 25M, 25Y, comprise 25K is a non-limiting example of a liquid container of the invention. Each of these four ink cartridges 25C, 25M, 25Y, and 25K are held in the horizontal position. These four ink cartridges 25C, 25M, 25Y, and 25K are arrayed as a line extending in the paper-width Y direction. Each of these four ink cartridges 25C, 25M, 25Y, and 25K has the shape of a flat-plate rectangular parallelepiped. A plurality of ink-supply tubes 26 are indirectly connected to one side of each of these four ink cartridges 25C, 25M, 25Y, and 25K. In the configuration of the printer 11 according to the present embodiment of the invention, the side of each of these four ink cartridges 25C, 25M, 25Y, and 25K where the ink-supply tubes 26 are connected is defined as a side face that extends length of the line head 12. In the illustrated example of FIG. 1, four ink-supply tubes 26 are indirectly joined to one side face of each of these four ink cartridges 25C, 25M, 25Y, and 25K. It should be noted that the number of ink-supply tubes 26 is not limited to four. Furthermore, each of the plurality of ink-supply tubes 26 comprises a non-limiting example of a liquid-supply channel of the invention. Each of the plurality of ink-supply tubes 26 branches into a plurality of individual ink-supply tube portions 26B. In the configuration of the printer 11 according to the present embodiment of the invention, each of the plurality of ink-supply tubes 26 branches into either three or four individual ink-supply tube portions 26B. Each of the plurality of branch ink-supply tube portions 26B of the ink-supply tube 26 are connected to the top of the corresponding unitary recording heads 15. It should be noted that there is no single unitary recording head 15 to which two or more branch ink-supply tube portions 26B of one ink-supply tube 26 are connected. With such a structure, ink supplied from each of the four ink cartridges 25C, 25M, 25Y, and 25K flows through the ink-supply tubes 26 and then reaches the unitary recording heads 15.

A cap unit 30 is provided at a position that is immediately beneath each of the unitary recording heads 15. Therefore, each of a plurality of cap units 30 faces the corresponding one of the unitary recording heads 15. Each of the plurality of cap units 30 is provided with a cap 31, a suction pump 32, and a cap elevation mechanism. The suction pump 32 supplies a suction force to the cap 31. The suction pump 32 is a non-limiting example of a negative pressure generation means. The cap elevation mechanism, which is not illustrated in the drawing, moves the cap 31 up and down. Each of the cap elevation mechanism elevates, that is, moves up and down, the corresponding cap 31 between a capping position and a retraction position, the latter of which is shown in FIG. 1. At the capping position, each of the plurality of the caps 31 is in contact with the nozzle surface 15A of the corresponding one of the plurality of unitary recording heads 15. At the retraction position, each of the plurality of the caps 31 is distanced from the nozzle surface 15A of the corresponding unitary recording head 15. The retraction position is the lowest possible position of each of the plurality of the caps 31. As a result of the vacuuming operation of the suction pump 32 when the cap 31 is in contact with the nozzle surface 15A of the unitary recording head 15, the inner pressure of the cap 31 becomes negative due to a suction force applied through a drain tube provided in the cap. This causes any ink that has become thickened in the nozzles in the nozzle surface 15A of the unitary recording head 15 and/or any air bubbles formed in the ink in the nozzles to be removed from the nozzle surface 15A of the unitary recording head 15. This operation is called cleaning.

FIG. 3 is a bottom view that schematically illustrates an example of the configuration of the line head 12 as viewed from the nozzle-surface 15A side according to an exemplary embodiment of the invention. The plurality of unitary recording heads 15 that make up the line head 12 are arrayed in a staggered pattern so as to form two lines, each of which extends along the paper-width Y direction. The bottom surface of each of the unitary recording heads 15 is formed as the above-mentioned nozzle surface 15A on which a number of nozzles are formed. Four nozzle lines 15B are formed on the nozzle surface 15A of each of the unitary recording heads 15. These four nozzle lines 15B correspond to a set of four ink colors. Each one of these four nozzle lines 15B is comprised of a plurality of nozzles that are arrayed with staggered pitch. In the configuration of the line head 12 and unitary recording head 15 according to the present embodiment of the invention, each one of these four nozzle lines 15B is made up of one hundred and eighty (180) nozzles. Each of the unitary recording heads 15 has four ink flow channels. These four ink flow channels are partitioned from one another inside the unitary recording head 15. These four ink flow channels correspond to the previously mentioned four nozzle lines 15B, which correspond to a set of four ink colors. Accordingly, ink of the corresponding colors is supplied to each of these four ink flow channels. Therefore, all nozzles that belong to the same nozzle line 15B eject ink having the same color.

Each of the unitary recording heads 15 has pressure-regulating valves in its inner components. The pressure-regulating valves are provided on each of the above-mentioned four individual ink flow channels that correspond to the four ink colors. Each of these pressure-regulating valves opens when the pressure of ink retained in an ink-retaining chamber or ink compartment, decreases to a predetermined value as a result of the consumption of ink due to the ejection of the ink from the nozzles. On the other hand, each of these pressure-regulating valves shuts when, as a result of the replenishment of ink, the amount of ink recovers the amount of ink that was consumed. That is, the pressure-regulating valve has a function of supplying ink to the ink-retaining chamber while maintaining the pressure of ink retained in the ink-retaining chamber at a substantially constant value. An ink-discharge driving element is provided for each nozzle of the unitary recording head 15. The ink-discharge driving element is provided inside the unitary recording head 15 at a position which corresponds to the ink-retaining chamber of each nozzle. It should be noted that neither the ink-discharge driving element or the ink-retaining chamber are illustrated in the drawing. As the ink-discharge driving element is driven, an ink-discharging force is applied to ink retained in the ink-retaining chamber. As a result thereof, ink drops are discharged from the nozzle. A few examples of a variety of ink-discharge driving methods include piezoelectric schemes, electrostatic actuation schemes, thermal ejection schemes, and the like, each of which may be adopted in association with the present invention. In the piezoelectric scheme, piezoelectric vibration elements are used as the ink-discharge driving elements. In the electrostatic actuation scheme, electrostatic actuators are used as the ink-discharge driving elements. In the thermal ejection scheme, a heater is used as the ink-discharge driving elements. In the configuration of the printer 11 according to the present embodiment of the invention, the ink cartridge 25, a cartridge holder 40, and the plurality of ink-supply tubes 26 make up a liquid supplying apparatus.

As has already been described above, the plurality of unitary recording heads 15 that form the line head 12 is arrayed in a staggered pattern so as to form two lines each of which extends along the paper-width Y direction. Because of such a two-line staggered array of the unitary recording heads 15, at one nozzle of the line-end portion of the nozzle lines 15B of the first-line unitary recording heads 15 overlap the nozzle(s) of the line-end portion of each of the nozzle lines 15B of the corresponding second-line unitary recording head 15 when viewed along the paper-transport X direction, that is, the vertical direction of FIG. 3. Or, alternatively, the line-end nozzle of each of the nozzle lines 15B of each of the first-line unitary recording heads 15 is set at a position that is separated from the line-end nozzle of each of the nozzle lines 15B of the corresponding second-line unitary recording head 15 by a distance that is equal to a fixed nozzle pitch. With such a nozzle array pattern, it is possible to perform printing on a sheet of printing paper having the maximum sheet size without any need to move the unitary recording heads 15.

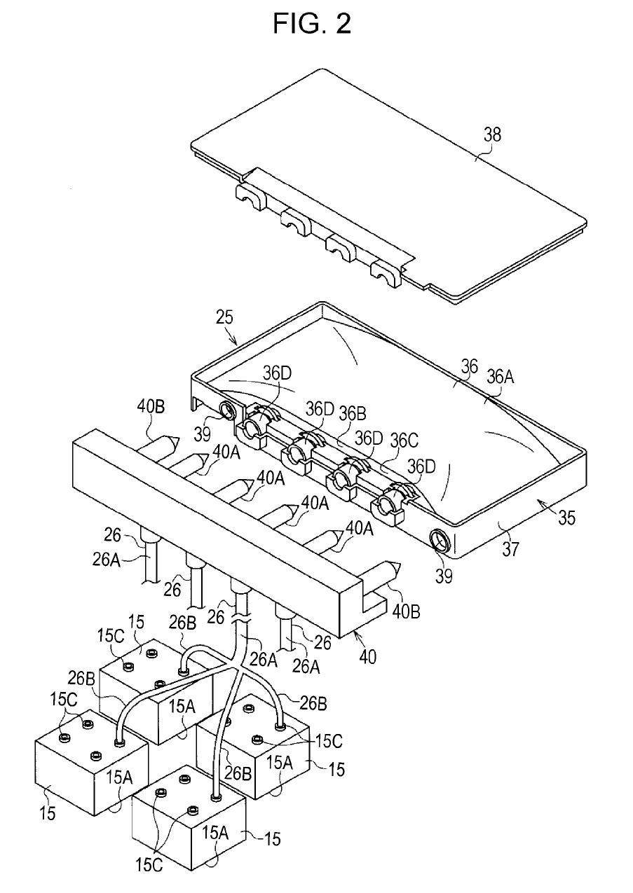

FIG. 2 is a perspective view that schematically illustrates an example of the configuration of an ink-supply apparatus according to the present embodiment of the invention. Regardless of ink colors, the aforementioned four ink cartridges 25C, 25M, 25Y, and 25K have an identical ink cartridge structure. Therefore, a common reference numeral 25 is assigned to an ink cartridge shown in FIG. 2 without making any differentiation for color as explained above. As shown in FIG. 2, the ink cartridge 25 has a cartridge case 35 and an ink pack 36. The ink pack 36 is encased in the cartridge case 35. The cartridge case 35 is made up of a case body 37 and a case cover 38. The ink pack 36, which is encased in the cartridge case 35, is made up of an ink bag 36A and an ink-supply member 36B. The ink bag 36A of the ink pack 36 has a laminated structure that is made up of a pair of resin films and a metallic foil that is disposed between the pair of resin films. A non-limiting example of the metallic foil that is used to make the ink bag 36A is aluminum. The ink bag 36A of the ink pack 36 has a substantially rectangular shape. One side of the ink bag 36A of the ink pack 36 is attached to the ink-supply member 36B thereof by means of a thermo-compression bonding method. The ink-supply member 36B of the ink pack 36 is made of a synthetic resin. The ink-supply member 36B has a base portion 36C. In the configuration of the ink pack 36 according to the present embodiment of the invention, a plurality of ink-supply-port units 36D are provided on the ink-supply member 36B. In the illustrated example, four ink-supply-port units 36D are provided. These four ink-supply-port units 36D, each of which has a cylindrical shape, protrude from the base portion 36C of the ink-supply member 36B. The ink pack 36 contains ink having one of the aforementioned four ink colors.

In an assembled state of the ink cartridge 25, the case cover 38 is attached to the case body 37 with the ink pack 36 being encased therein. The assembled ink cartridge 25 has the shape of a flat-plate rectangular parallelepiped. The above-mentioned four ink-supply-port units 36D are partially exposed to the outside through one side face of the ink cartridge 25. In the configuration of the ink cartridge 25 according to the present embodiment of the invention, the exposed face is defined as a side face which extends along one of the longer sides of the ink pack 36. A pair of positioning holes 39 are formed in the exposed face of the cartridge 25. The above-mentioned four ink-supply-port units 36D are provided between the positional determination holes 39.

The printer 11 has a cartridge attachment concave portion, which is not illustrated in the drawing. The ink cartridge 25 is detachably attached to the cartridge attachment concave portion of the printer 11. The aforementioned cartridge holder 40, which is illustrated in FIG. 2, is provided in the cartridge attachment concave region of the printer 11. The cartridge holder 40 has four ink-supply needles (or ink intake needles) 40A. The cartridge holder 40 further has a pair of positioning pins 40B. The four ink-supply needles 40A protrude at positions corresponding to the positions of the four ink-supply-port units 36D. On the other hand, the two positioning pins 40B protrude at positions which correspond to the position of the pair of positioning holes 39. At the time when the ink cartridge 25 is attached to the cartridge attachment concave portion of the printer 11, each of the positioning pins 40B is inserted into the corresponding positioning hole 39, thereby ensuring proper attachment of the ink cartridge 25 to the cartridge attachment concave portion. In this cartridge-attached state, each of the above-mentioned four ink-supply needles 40A is inserted through the corresponding ink-supply-port unit 36D. As a result, ink contained inside the ink pack 36 can flow through the four ink-supply tubes 26, each of which is connected to the bottom surface of the cartridge holder 40 at one end, so as to be able to reach each of the unitary recording heads 15. The ink cartridge 25 is held in the horizontal position. The ink cartridge 25 is attached to the cartridge attachment concave portion of the printer 11 in such a manner that the length of the cartridge is substantially parallel to the array direction of the unitary recording heads 15, which is the paper-width Y direction shown in FIG. 1. Each of the unitary recording heads 15 has a plurality of projecting portions 15C for tube connection, the number of which is equal to the number of ink colors. In the configuration of the printer 11 according to the present embodiment of the invention, the number of tube-connection projecting portions 15C of each of the unitary recording heads 15 is four. As illustrated in FIG. 2, these four tube-connection projecting portions 15C are formed on the top of each of the unitary recording heads 15. Each of the individual ink-supply tube portions 26B that branch from the ink-supply tube 26 that are indirectly connected to the ink cartridge 25 by means of the cartridge holder 40 are connected to the corresponding tube-connection projecting portion 15C of the corresponding unitary recording head 15 that belongs to the same main-tube group of the unitary recording heads 15. It should be noted that the ink cartridge 25 shown in FIG. 2 could be any one of the aforementioned four-ink-color ink cartridges 25C, 25M, 25Y, and 25K. For example, if it is assumed herein just for the purpose of explanation that the ink cartridge 25 shown in FIG. 2 is a yellow ink cartridge 25Y, the branch ink-supply tube portions 26B of the ink-supply tubes 26 that are indirectly connected to the remaining three cyan, magenta, and black ink cartridges 25C, 25M, and 25K, respectively, are connected to the remaining three of the aforementioned four tube-connection projecting portions 15C, respectively. As will be understood from the above explanation, the four tube-connection projecting portions 15C correspond to a set of four ink colors. With such a structure, ink of all four colors can be supplied to each of the plurality of unitary recording heads 15 through the ink-supply tubes 26, each of which is dedicated to supplying ink of one color.

As shown in FIGS. 1 and 2, each of the ink-supply tubes 26 are made up of a single main ink-supply tube portion 26A and a plurality of the individual ink-supply tube portions 26B. Each of the individual ink-supply tube portions 26B of the ink-supply tube 26 branches from the single main ink-supply tube portion 26A thereof. In the configuration of the ink-supply tube 26 according to the present embodiment of the invention, three or four individual ink-supply tube portions 26B branch from one main ink-supply tube portion 26A. The main ink-supply tube portion 26A of the ink-supply tube 26 constitutes an upstream-side portion thereof, which is closer to the ink cartridge 25, whereas the branch ink-supply tube portions 26B thereof constitute a downstream-side portion thereof. The main ink-supply tube portion 26A of the ink-supply tube 26 occupies the majority of the entire length of the ink-supply tube 26. For example, the main ink-supply tube portion 26A of the ink-supply tube 26 accounts for 80-95% of the entire length of the ink-supply tube 26. On the other hand, the branch ink-supply tube portions 26B of the ink-supply tube 26 occupy the minority of the entire length of the ink-supply tube 26. For example, the branch ink-supply tube portions 26B of the ink-supply tube 26 accounts for 5-20% of the entire length of the ink-supply tube 26. In the configuration of the ink-supply tube 26 according to the present embodiment of the invention, each of the branch ink-supply tube portions 26B has a caliber or inner diameter that is smaller than that of the main ink-supply tube portion 26A. In addition to the above, in comparison with the configuration of an ink-supply apparatus of the related art that has only one ink-supply tube, the value of the inner diameter of the main ink-supply tube portion 26A of each of the ink-supply tubes 26 according to the present embodiment of the invention is approximately a half of that of the related-art ink-supply tube. This is because the flow amount of ink per ink-supply tube according to the invention is reduced to a value that is obtained as a result of the division of the flow amount of ink that is offered by the single ink-supply tube of the related art by the number of the ink-supply tubes of the invention. For example, In the configuration of the printer 11 according to the present embodiment of the invention, the amount of ink flowing in each ink-supply tube 26 is reduced to a value that is equal to the amount of ink flowing in the single ink-supply tube of the related art divided by the number of the ink-supply tubes 26, which is four. Accordingly, the ink-flow sectional area of the main ink-supply tube portion 26A of each of the ink-supply tubes 26 according to the present embodiment of the invention is reduced by approximately one fourth (¼) of that of the related-art ink-supply tube. More specifically, aside from any pressure loss that may occur due to the decreasing of the inner diameter of the main ink-supply tube portion 26A of each of the ink-supply tubes 26, the use of the plurality of (e.g., four) ink-supply tubes 26 according to the present embodiment of the invention ensures substantially the same amount of ink flow as that offered by the single ink-supply tube of the related art.

The ink cartridge 25 is attached at a level (i.e., position) that is higher than that of the nozzle surface 15A of each of the unitary recording heads 15 by a predetermined distance in the direction opposite to gravity. Such a configuration offers ink-supply pressure that is high enough for ink to travel from the ink cartridge 25 to the nozzles of each of the unitary recording heads 15 because using the difference in the water head.

In one embodiment, the ink-supply tubes 26 is made of a synthetic resin material so as to ensure a good flexibility, although the invention is not limited thereto. The synthetic resin material has liquid permeability and gas permeability that are higher than those of other material such as a metallic material. In view of the foregoing fact, it is preferable to select a synthetic resin material that features relatively low liquid permeability and gas permeability among a variety of synthetic resin materials for the ink-supply tube 26. A non-limiting preferred example of a tube material is a fluorocarbon resin.

In the illustrated example of FIG. 1, the number of unitary recording heads 15 that make up the line head 12 is fourteen. On the other hand, the number of ink-supply tubes 26 that are provided for ink of each color (i.e., liquid of the same type) is four. Accordingly, the number of unitary recording heads 15 that make up the line head 12 cannot be divided by the number of ink-supply tubes 26 that are provided for ink of each color without remainder. For this reason, as shown in FIG. 1, there are two branch types in the configuration of the ink-supply tube 26. Specifically, each of the ink-supply tubes 26 of the first branch type has four individual ink-supply tube portions 26B which can be connected to the unitary recording head 15, or, in other words, has a branch structure which connects to four unitary recording heads 15. On the other hand, each of the ink-supply tubes 26 of the second branch type has three individual ink-supply tube portions 26B which can be connected to the unitary recording head 15, or, in other words, has a branch structure for connecting to three unitary recording heads 15.

In the configuration of the printer 11 according to the present embodiment of the invention, as shown in FIG. 1, the ink-supply tube 26 of the second branch type which has three individual ink-supply tube portions 26B is provided for the two groups of three unitary recording heads 15 at each end of the line head 12. Each of these three branch ink-supply tube portions 26B are connected to the corresponding one of these three unitary recording heads 15. On the other hand, the ink-supply tube 26 of the first branch type which has four individual ink-supply tube portions 26B is provided for the two centermost groups of four unitary recording heads 15 that are each adjacent to the groups of three unitary recording heads 15 and the other group of four unitary recording heads 15. Each of these four branch ink-supply tube portions 26B are connected to the corresponding unitary recording head 15. That is, in the configuration of the printer 11 according to the present embodiment of the invention, a plurality of unitary recording heads 15 are divided into a plurality of groups of unitary recording heads 15 in such a manner that the number thereof at one side is equal to the number thereof at the other side of the line head 12, that is, as viewed along the width of the printer 11 (i.e., the paper-width Y direction). The ink-supply tubes 26 of each branch type have enough branch ink-supply tube portions 26B to correspond the number of unitary recording heads 15 that are assigned to that branch type, such that each of the branch ink-supply tube portions 26B of the ink-supply tube 26 are connected to a corresponding unitary recording head 15. In this way, the ink cartridge 25 is connected to all unitary recording heads 15 of each group. Note that the number of unitary recording heads 15 that make up the line head 12 may be arbitrarily modified depending on the maximum sheet size of printing paper on which the printer 11 can perform printing and the body size of each of the unitary recording heads 15.

In the configuration of the printer 11 according to the present embodiment of the invention described above, ink contained in the ink cartridge 25, or, more specifically, in the ink pack 36, is supplied to the respective unitary recording heads 15 through the plurality of ink-supply tubes 26, which means that ink is supplied via parallel ink-supply routes. Advantageously, this makes it is possible to reduce a difference in the length of the ink-supply routes among the plurality of unitary recording heads 15. As a result thereof, it is possible to reduce the pressure loss that occurs during when ink travels from the ink cartridge 25 to the respective unitary recording heads 15. For this reason, it is further possible to reduce unevenness in the ink supplying to the respective unitary recording heads 15. Since it is possible to effectively decrease variations and differences in the amount of ink that is ejected from the plurality of unitary recording head 15, it is further possible to improve print quality.

In addition to the above, in comparison with the configuration of an ink-supply apparatus of the related art that uses only one ink-supply tube, an ink-supply apparatus according to the present embodiment of the invention makes it possible to shorten the maximum length of the ink-supply routes from the ink cartridge 25 to the respective unitary recording heads 15. Generally speaking, during the time when the ink travels inside a resin-made ink tube from an ink cartridge to a recording head, the moisture of ink evaporates through the resin into air. In addition, during the time when the ink travels in the resin-made ink tube, external gas (e.g., air) permeates through the resin-made ink tube and becomes dissolved in the ink. As the length of the ink-supply route lengthens, the retention time of ink that travels inside the ink-supply tube becomes longer. Or, in other words, as an ink-supply route lengthens, the length of a time period during which ink remains inside the ink-supply tube increases. As the ink-retention time becomes longer, the amount of permeation of moisture and/or gas that permeates through the ink-supply tube that is made of a resin material increases. As a result thereof, the evaporation of the moisture from ink and/or the dissolution of gas into ink in the supply tube increases. If the level of the evaporation of the moisture from ink exceeds a certain threshold value, the thickness level of ink remaining in nozzles and/or the thickness level of ink retained inside ink-retaining chambers could be raised so as to cause or induce the clogging of the nozzles. If the level of the dissolution of gas into ink exceeds a certain threshold value, air bubbles may form in ink remaining in nozzles and/or ink retained inside ink-retaining chambers. In this respect, as explained above, an ink-supply apparatus according to the present embodiment of the invention makes it possible reduce the length of the ink-supply routes from an ink cartridge to the respective unitary recording heads from those in ink-supply apparatuses of the related art. Therefore, it is possible to shorten the above-mentioned ink-retention time period, thereby effectively reducing the amount of evaporation in the ink and/or the degree of the dissolution of gas into ink, or the frequency of such problems. Therefore, despite the fact that each of ink-supply tubes is made of a resin material that has liquid permeability and gas permeability higher than those of other material such as a metallic material or the like, an ink-supply apparatus according to the present embodiment of the invention has an advantage over an ink-supply apparatus of the related art in that it is possible to reduce the occurrences of an ink-discharge failure that is attributable to the clogging of nozzles and/or the formation of air bubbles inside ink, thereby improving ink-discharging performance.

As explained in detail above, the ink-supply apparatus according to the present embodiment of the invention offers the following advantages:

(1) In the configuration of an ink-supply apparatus according to the present embodiment of the invention, a plurality of ink-supply tubes 26 is connected to the ink cartridge 25. In addition, the ink cartridge 25 is connected to the tube-connection projecting portions 15C of the unitary recording heads 15 via the plurality of ink-supply tubes 26. In comparison with the configuration of an ink-supply apparatus of the related art wherein a single ink-supply tube extends so as to offer a single main ink-supply route for supplying ink to the tube-joint portion of each of the plurality of unit recording heads, an ink-supply apparatus according to the present embodiment of the invention offers shorter main ink-supply routes for supplying ink to the liquid-supply reception ports 15C of the respective unitary recording heads 15. Therefore, advantageously, an ink-supply apparatus according to the present embodiment of the invention makes it possible to reduce the length of the ink-supply routes from the ink cartridge 25 to the tube-connection projecting portions 15C of the respective unitary recording heads 15. For this reason, it is further possible to reduce inconsistencies in the supply of ink to the respective unitary recording heads 15.

(2) Even if it is assumed that the traveling speed of ink that flowing inside each of the plurality of ink-supply tubes 26 is the same as the traveling speed of ink that flowing inside a single ink-supply tube of the related art, it is possible to shorten the amount of time that the ink is retained inside each of the plurality of ink-supply tubes 26 because of the shortened length of each of the plurality of ink-supply tubes 26. As the ink-retention time of each of the plurality of ink-supply tubes 26 is shorter than that of the single ink-supply tube of the related art, making it possible to decrease the degree of permeation of moisture and/or gas through the ink-supply tube 26, further decreasing the evaporation of the moisture from ink and/or the dissolution of gas into ink. Therefore, an ink-supply apparatus according to the present embodiment of the invention has an advantage over an ink-supply apparatus of the related art in that it is possible to reduce the occurrences of an ink-discharge failures that are attributable to the clogging of nozzles caused by ink with increased thickness as a result of evaporation and/or the formation of air bubbles inside ink caused as a result of the dissolution of gas therein, thereby improving ink-discharging performance.

(3) Each of the plurality of ink-supply tubes 26 branches into a plurality of individual ink-supply tube portions 26B. Each of the plurality of branch ink-supply tube portions 26B of the ink-supply tube 26 are connected to a tube-connection projecting portion 15C of a corresponding unitary recording heads 15. Herein, there is no same single unitary recording head 15 to which two or more branch ink-supply tube portions 26B of a single ink-supply tube 26 are connected. Therefore, the number of the ink-supply tubes 26 is relatively small in comparison with the relatively large number of the tube-connection projecting portions 15C of the unitary recording heads 15. As previously described, in the configuration of an ink-supply apparatus according to the present embodiment of the invention, each of the plurality of ink-supply tubes 26 branches into either three or four individual ink-supply tube portions 26B. Although the line head 12 is made up of the plurality of unitary recording heads 15, because of the above-described branch structure, it is possible to make the number of ink-supply tubes 26 that is required for each ink color relatively small in comparison with the relatively large number of the tube-connection projecting portions 15C of the unitary recording heads 15. More specifically, it is possible to reduce the number of ink-supply tubes 26 to one third to one fourth (⅓-¼) of the number of the tube-connection projecting portions 15C of the unitary recording heads 15. Such a structure is advantageous in that it is easier to connect the ink-supply tubes 26 to the ink cartridge 25 and the unitary recording heads 15.

(4) The ink cartridge 25 has the shape of a rectangular plate, which is an example of an anisotropic shape. The above-mentioned four ink-supply-port units 36D are partially exposed to the outside through one side of the ink cartridge 25, where the exposed face extends along longer side of the ink cartridge 25. Such a structure is advantageous in that it is possible to secure a connection space that is wide enough for the connection of the plurality of ink-supply tubes 26. In addition, it is possible to increase design flexibility in the selection of connection places.

Although a liquid supplying apparatus, a liquid ejecting apparatus, and a liquid supplying method having distinctively unique features of the present invention is described above while explaining preferred exemplary embodiments, the invention should be in no case interpreted as being limited to the specific embodiments described above. The invention may be modified, altered, changed, adapted, and/or improved within the range and scope of the invention apprehended by a person skilled in the art from explicit and implicit description made herein, where such a modification, an alteration, a change, an adaptation, and/or an improvement is also covered by the scope of the appended claims. The following are a few non-limiting examples of a modifications, alterations, changes, adaptations, and/or improvements of the preferred exemplary embodiments described above.

### VARIATION EXAMPLE 1

In the foregoing exemplary embodiment of the invention, the ink-supply tube 26 of the second branch type that has three individual ink-supply tube portions 26B is provided for each end group of three unitary recording heads 15, whereas the ink-supply tube 26 of the first branch type that has four individual ink-supply tube portions 26B is provided for each of two centermost groups of four unitary recording heads 15. However, the scope of the invention is not limited to such an exemplary configuration. For example, as illustrated in FIG. 4, the number of the branch ink-supply tube portions 26B of the ink-supply tube 26 that are connected to the tube-connection projecting portions 15C of the unitary recording heads 15of the two end groups, which is further from the ink cartridge 25, may be larger than the number of the branch ink-supply tube portions 26B of the ink-supply tube 26 that connected to the tube-connection projecting portions 15C of the center-most unitary recording heads 15. More specifically, in a non-limiting modification example illustrated in FIG. 4, the ink-supply tube 26 of the first branch type that has four individual ink-supply tube portions 26B may be provided for each end group which comprises four unitary recording heads 15, while two ink-supply tubes 26 of the second branch type with three individual ink-supply tube portions 26B is provided for the two center-most groups of three unitary recording heads 15 of the line head 12. Accordingly, the number of the branch ink-supply tube portions 26B of the ink-supply tube 26 that are connected to the tube-connection projecting portions 15C of the unitary recording heads 15 that belong to the two end groups of four, which are further from the ink cartridge 25, may be is larger than the number of the branch ink-supply tube portions 26B of the ink-supply tube 26 that are connected to the tube-connection projecting portions 15C of the unitary recording heads 15 that belong to the center-most groups of three. The length of the ink-supply tube 26 that is connected to relatively remote unitary recording heads 15 is relatively longer. As the length of the ink-supply tube 26 increases, the length of time during which ink remains inside the ink-supply tube 26 before reaching the unitary recording heads 15 increases. The modified configuration described above, which has more branches for relatively remote group of unitary recording heads 15, is advantageous in that it can shorten the ink-retention time. Specifically, the ink-supply tube 26 that has a relatively large number of branches has a relatively large number of ink-supply destination unitary recording heads 15. Since the number of the unitary recording heads 15 that are connected to the ink-supply tube 26 having more branches is relatively large, the speed of consumption of ink in those branches is higher. Although the plurality of ink-supply tubes 26 has the same inner diameter, the traveling speed of ink that flows inside the ink-supply tube 26 having more branches is higher because of the increased consumption speed. Since the traveling speed of ink that flows inside the ink-supply tube 26 having more branches is higher, the length of time during which ink remains inside the ink-supply tube 26 having a relatively large number of branches is shorter before the ink reaches the unitary recording heads 15. Therefore, it is possible to make ink-retention time relatively short even though, for example, the remote end-side ink-supply route is relatively long. Thus, it is possible to decrease the degree of permeation of moisture and/or gas through even some ink-supply tube 26 having a relatively long ink-supply route, thereby further decreasing the evaporation of the moisture from ink and/or the dissolution of gas into ink.

### VARIATION EXAMPLE 2

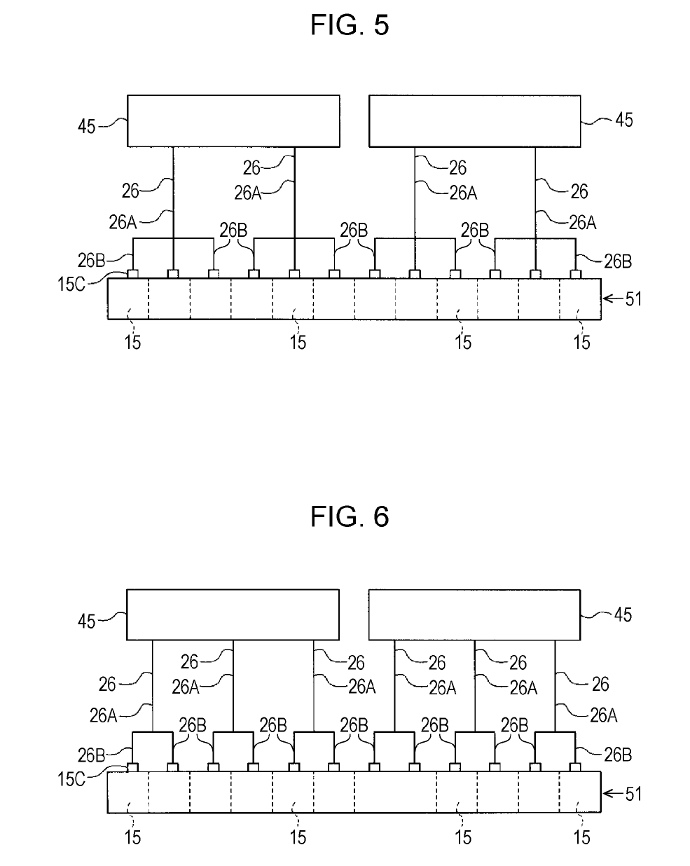

In the foregoing exemplary embodiment of the invention, a single ink cartridge 25 (liquid container) only is provided for ink of one color. However, the scope of the invention is not limited this exemplary configuration. For example, a plurality of liquid containers may be provided for liquid of the same type. In a non-limiting modification example illustrated in FIG. 5, two ink cartridges 45 that contain the same color ink are provided. The pair of ink cartridges 45 comprise non-limiting examples of liquid containers according to the invention. A plurality of ink-supply tubes 26 extends from each of these two ink cartridges 45. Each of the plurality of ink-supply tubes 26 branches into a plurality of individual ink-supply tube portions 26B. Each of the plurality of branch ink-supply tube portions 26B of each of the plurality of ink-supply tubes 26 are connected to the tube-connection projecting portion 15C of corresponding unitary recording heads 15. Herein, there is no same single unitary recording head 15 to which two or more branch ink-supply tube portions 26B of one (i.e., same single) ink-supply tube 26 are connected. It should be noted that a line head 51 illustrated in FIG. 5 is not made up of a plurality of recording heads arrayed throughout the entire width of a sheet of printing paper having the maximum sheet size but comprises only one single elongated head. The illustrated line head 51 is a non-limiting example of a liquid ejecting head that may be used in association with the invention. The line head 51 has a plurality of ink flow channels that are partitioned from one another inside therein and extend along the length of the line head 51 In the configuration of the line head 51 shown in FIG. 5, a head portion that corresponds to each partitioned individual flow channel functions as the unitary recording head (unit head) 15.

### VARIATION EXAMPLE 3

As shown in FIG. 6, the plurality of ink-supply tubes 26 that extend from the ink cartridges 45 may have the equal liquid-supply route lengths. In this example, the length of a liquid-supply route is embodied as the length of the ink-supply tube 26 extending from the ink cartridge 45 to the tube-connection projecting portion 15C of the unitary recording head 15. The illustrated tube-connection projecting portion 15C is a non-limiting example of a liquid-supply reception port according to the invention. The illustrated pair of ink cartridges 45 comprise non-limiting examples of liquid containers according to the invention. The illustrated line head 51 comprises a non-limiting example of a liquid ejecting head according to the invention. In the non-limiting modification example illustrated in FIG. 6, the lengths of liquid-supply routes from the ink cartridges 45 to the tube-connection projecting portions 15C of the unitary recording heads 15 are equal. With such a configuration, it is possible to eliminate any unevenness in the ink supply to the tube-connection projecting portions 15C of the unitary recording heads 15. In the non-limiting modification example illustrated in FIG. 6, the lengths of the plurality of branch ink-supply tube portions 26B of the plurality of the ink-supply tubes 26 are also equal. Notwithstanding the foregoing, however, the lengths of the plurality of branch ink-supply tube portions 26B of the plurality of the ink-supply tubes 26 may not be equal to one another as long as the lengths of liquid-supply routes from the ink cartridges 45 to the tube-connection projecting portions 15C of the unitary recording heads 15 are equal. In the non-limiting modification example illustrated in FIG. 6, the number of the branch ink-supply tube portions 26B of each of the plurality of the ink-supply tubes 26 is two. However, the scope of this modification example is not limited to such an illustrated exemplary configuration. For example, the number of the branch ink-supply tube portions 26B of each of the plurality of the ink-supply tubes 26 may be three or more, which can be arbitrarily determined in an actual implementation of the invention. In the non-limiting modification example illustrated in FIG. 6, a plurality of ink cartridges 45 is provided for each ink color. However, the scope of this modification example is not limited to such an illustrated exemplary configuration. For example, the single ink cartridge 25 may be provided for ink of the same type as in the foregoing exemplary embodiment of the invention and the first variation example illustrated in FIG. 4 with the modified features described herein.

### VARIATION EXAMPLE 4

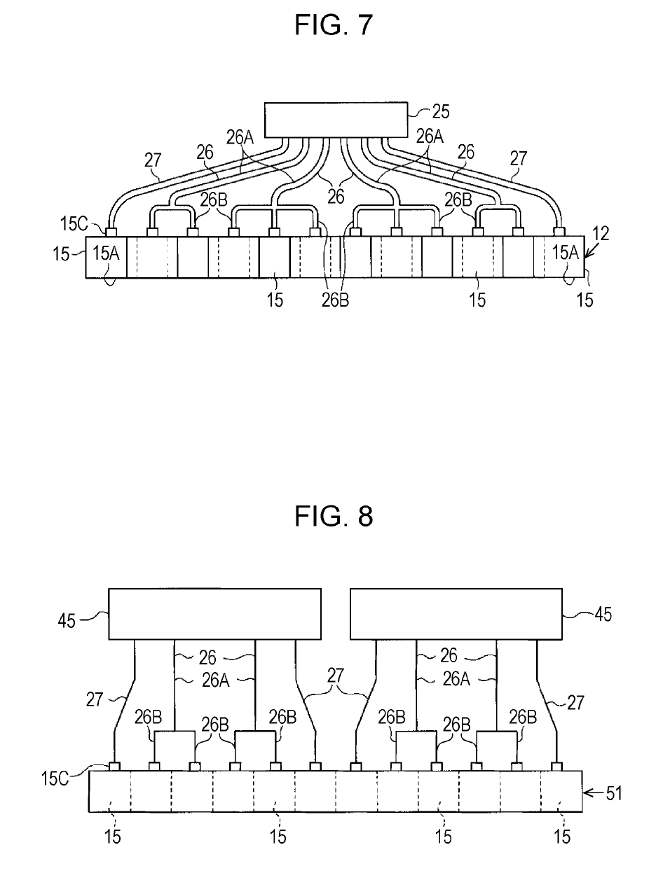

In the foregoing exemplary embodiment of the invention, each of the plurality of ink-supply tubes 26 branches into the plurality of individual ink-supply tube portions 26B. However, the scope of the invention is not limited to such an exemplary configuration. For example, some of the plurality of ink-supply tubes 26 may be configured as a branchless tube that does not have any branch ink-supply tube portion 26B. In the non-limiting modification example illustrated in FIG. 7, a branchless tube 27, which does not have any branch ink-supply tube portion 26B, is provided that extends from the ink cartridge 25. Each of the branchless tubes 27 that extend from the ink cartridge 25 is connected to the tube-connection projecting portion 15C of the corresponding unitary recording head 15 at each end of the length of the line head 51. The illustrated tube-connection projecting portion 15C is a non-limiting example of a liquid-supply reception port according to the invention. In addition, in the non-limiting modified configuration illustrated in FIG. 7, the number of the branch ink-supply tube portions 26B of the ink-supply tube 26 decreases as the length of an ink flow channel increases. Specifically, the two three-branch ink-supply tubes 26 that have three individual ink-supply tube portions 26B are connected to the two center-most groups of three unitary recording heads 15, which are relatively close to the ink cartridge 25 and constitute first recording-head groups. Two two-branch ink-supply tubes 26 that have two individual ink-supply tube portions 26B are connected to two groups of two unitary recording heads 15 which constitutes a second recording-head group. Two branchless ink-supply tubes 27 with no individual ink-supply tube portion 26B are connected to each end unitary recording head 15, which are furthest from the ink cartridge 25. As explained above, in the non-limiting modified configuration illustrated in FIG. 7, the number of the branch ink-supply tube portions 26B of the ink-supply tube 26 decreases as the length of an ink flow channel increases. With such a configuration, even when a water-head-difference ink-supply scheme that utilizes a water head difference for the supplying of ink is adopted, it is possible to reduce unevenness in ink-supply pressure for the supplying of ink to the tube-connection projecting portions 15C of the unitary recording heads 15. For this reason, it is further possible to effectively decrease variations and differences in the amount of ink that is ejected from the plurality of unitary recording head 15 due to an uneven ink-supply pressure.

The above-described branchless ink-supply tube 27 may be applied to the aforementioned plural ink-cartridge configuration which has the plurality of ink cartridges 45 provided for ink of the same color. In the non-limiting modification example illustrated in FIG. 8, some of ink-supply tubes that connect the ink cartridges 45 and the unitary recording heads 15 are configured as the branchless ink-supply tubes 27. In the non-limiting modification example illustrated in FIG. 8, a branchless tube 27, which do not have any branch ink-supply tube portions 26B, are provided at each end of the ink cartridges 45. Each of the branchless tubes 27 that extend from each of the ink cartridges 45 is connected to the tube-connection projecting portion 15C of the corresponding one of the plurality of unitary recording heads 15. In the illustrated example, there are six unitary recording heads 15 to which each of the ink cartridges 45 supplies ink. Among these six unitary recording heads 15, each of the end branchless tubes 27 that extend from the ink cartridge 45 are connected to a corresponding end unitary recording head 15 that is furthest from the ink cartridge 45. It should be noted that the number of unitary recording heads 15 that make up the ink-supply destination of each of the ink cartridges 45 is not limited to six. In each of the modified configurations illustrated in FIGS. 7 and 8, each of the branchless tubes 27 that extend from the ink cartridge 25/45 are connected to a corresponding end unitary recording head 15 that is furthest from the ink cartridge 45 and thus has the longest ink flow channel from the ink cartridges 25 and 45. With such a configuration, the relatively large pressure loss that is attributable to the relatively long flow channel can be effectively offset with relatively small pressure loss offered by the branchless structure of the branchless tubes 27. For this reason, it is possible to reduce unevenness of the ink supply through the ink-supply tubes 26, 27 to the respective unitary recording heads 15.

### VARIATION EXAMPLE 5

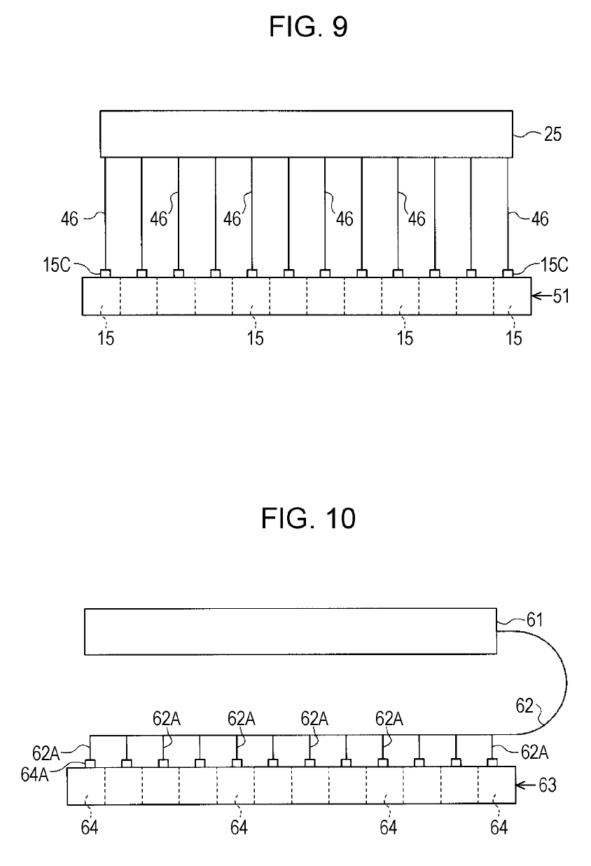

In the foregoing exemplary embodiment of the invention, each of the plurality of ink-supply tubes 26 branches into a plurality of individual ink-supply tube portions 26B. However, the scope of the invention is not limited to such an exemplary configuration. For example, the plurality of ink-supply tubes 26 may be configured as a branchless tubes that do not have any branch ink-supply tube portions 26B. Specifically, as shown in FIG. 9, a branchless ink-supply tube 46, which does not have any branch ink-supply tube portion, may be provided for connection between the tube-connection projecting portion 15C each of the unitary recording heads 15 and the ink cartridge 25. The illustrated tube-connection projecting portion 15C is a non-limiting example of a liquid-supply reception port according to the invention. The illustrated ink cartridge 25 is a non-limiting example of a liquid container according to the invention. Since the plurality of branchless ink-supply tubes 46 have the same length, it is possible to eliminate any unevenness in the supplying of ink to the tube-connection projecting portions 15C of the unitary recording heads 15.

### VARIATION EXAMPLE 6

In the foregoing exemplary embodiment of the invention, an ink cartridge is taken as an example of an ink container. However, the scope of the invention is not limited to such an exemplary configuration. For example, an ink tank may be used as an ink container. The aforementioned water-head-difference ink-supply scheme that utilizes a water head difference for the supplying of ink may be adopted as a method for supplying ink from the ink tank. In the modified configuration described above, it is preferable that ink-supply tubes should extend from a side face that extends along the longest side of the ink container.

### VARIATION EXAMPLE 7

Branched ink-supply tubes having some branch ink-supply tube portions and branchless ink-supply tubes having no branch ink-supply tube portions may be mixed. Note that it is not always necessary for a branchless ink-supply tube having no branch ink-supply tube portions to be connected to an unitary recording head that is disposed at the end of line thereof. For example, a branchless ink-supply tube having no branch ink-supply tube portions may be connected to the tube-connection projecting portion 15C of a centermost unitary recording head 15. In addition, the number of the branch ink-supply tube portions of the ink-supply tube may be five or more.

### VARIATION EXAMPLE 8

The type of a printer that constitutes a non-limiting example of a liquid ejecting apparatus according to the invention is not limited to a line printer. For example, the invention can be applied to a serial printer, which is provided with a carriage.

### VARIATION EXAMPLE 9

In the configuration of the printer 11 according to the foregoing exemplary embodiment of the invention, it is explained that a liquid ejecting apparatus is embodied as an ink-jet recording apparatus. However, the scope of the invention is not limited to such an exemplary configuration. For example, the invention is applicable to a variety of liquid ejecting apparatuses that ejects or discharges various kinds of liquid that includes ink but is not limited thereto. The invention is further applicable to a liquid ejecting apparatus that ejects a liquid/liquefied matter/material that is made as a result of dispersion or mixture of particles of functional material(s) into/with liquid. The invention is further applicable to a liquid ejecting apparatus that ejects a gel substance. The invention is further applicable to a liquid ejecting apparatus that ejects a semi-solid substance that can be ejected as a liquid. It should be noted that the scope of the invention is not limited to those enumerated above. In addition to an ink-jet recording apparatus described in the foregoing exemplary embodiment of the invention, a liquid ejecting apparatuses to which the invention is applicable encompasses a wide variety of other types of apparatuses that ejects liquid or fluid in which, for example, a color material (pixel material) or an electrode material is dispersed or dissolved, though not necessarily limited thereto. Herein, the color material may be, for example, one that is used in the production of color filters for a liquid crystal display device or the like. The electrode material (i.e., conductive paste) may be, though not limited thereto, one that is used for electrode formation of an organic EL display device, a surface/plane emission display device (FED), and the like. A liquid ejecting apparatuses to which the invention is applicable further encompasses a wide variety of other types of apparatuses such as one that ejects a living organic material used for production of biochips or one that is provided with a sample ejection head functioning as a high precision pipette and ejects liquid as a sample. Further in addition, the invention is applicable to, and thus can be embodied as, a liquid ejecting apparatus that ejects, with high precision, lubricating oil onto a precision instrument and equipment including but not limited to a watch and a camera. Moreover, the invention is applicable to and thus can be embodied as a liquid ejecting apparatus that ejects liquid of a transparent resin such as an ultraviolet ray curing resin or the like onto a substrate so as to form a micro hemispherical lens (optical lens) that is used in an optical communication element or the like. Furthermore, the invention is applicable to and thus can be embodied as a liquid ejecting apparatus that ejects an etchant such as acid or alkali that is used for the etching of a substrate or the like. Further in addition, the invention is applicable to and thus can be embodied as a liquid ejecting apparatus that ejects a gel liquid (e.g., physical gel). In the description of this specification and the recitation of appended claims, the term “liquid” is defined as a broad generic concept that encompasses a variety of liquid matter/material/substance that includes but not limited to liquid matter/material/substance. Only one exception thereof is “gas-only” liquid (i.e., liquid that is made up of gas only). For example, the liquid includes, without any limitation thereto, inorganic solvent, organic solvent, solution, liquid resin, and liquid metal (e.g., metal melt).

The following is one aspect of the technical concept of the invention that can be understood from the foregoing exemplary embodiments of the invention and variation examples thereof described above.

(1) In the configuration of a liquid supplying apparatus according to any of claims 1 to 7, it is preferable that each of the plurality of liquid-supply channels should be made of a synthetic resin. Therefore, even though each of the plurality of liquid-supply channels is made of a resin material that has liquid permeability and gas permeability higher than those of other material such as a metallic material or the like, in comparison with the configuration of a liquid supplying apparatus of the related art that has only one liquid-supply channel, a liquid supplying apparatus according to an aspect of the invention makes it possible to shorten the maximum length of liquid-supply routes from at least one liquid container to the liquid-supply reception ports of a plurality of liquid ejecting heads. Such a unique configuration of a liquid supplying apparatus according to an aspect of the invention makes it possible to shorten the retention time of liquid, that is, the length of a time period during which liquid remains inside each of the plurality of liquid-supply channels. Since the length of a time period during which liquid remains inside each of the plurality of liquid-supply channels is shortened, it is possible to reduce the degree (e.g., percentage) of permeation of moisture through each of the plurality of liquid-supply channels and/or external gas through each of the plurality of liquid-supply channels, even though it is made of a synthetic resin material. As a result thereof, it is possible to further reduce the evaporation of the liquid and/or the dissolution of external gas such as air into liquid.

(2) It is preferable that a liquid supplying apparatus according to any of claims 1 to 7 should further have a flow channel holder (40) to which a liquid container is detachably attached, wherein a connection is established between the liquid container and the plurality of liquid-supply channels that extend from the flow channel holder at the time when the liquid container is detachably attached to the flow channel holder.

What is claimed is:

1. A liquid supplying apparatus that is attached to a liquid ejecting apparatus for supplying liquid to a plurality of liquid ejecting heads of the liquid ejecting apparatus, the liquid supplying apparatus comprising:
at least one liquid container capable of containing liquid; and
a plurality of liquid-supply channels which are connected to the at least one liquid container and are capable of supplying liquid from the at least one liquid container to the plurality of liquid ejecting heads by utilizing a difference in the water head between the liquid container and plurality of liquid ejecting head,
wherein each of the plurality of liquid-supply channels are connected to a plurality of corresponding liquid-supply reception ports of the plurality of liquid ejecting heads and the number of the liquid-supply reception ports of the liquid ejecting heads is larger than the number of the liquid-supply channels.

2. The liquid supplying apparatus according to claim 1, wherein some of the plurality of liquid-supply channels branch into a plurality of branch liquid-supply channel portions which are connected to the corresponding liquid-supply reception ports of the plurality of liquid ejecting heads.

3. The liquid supplying apparatus according to claim 1, wherein each of the plurality of liquid-supply channels branches into a plurality of branch liquid-supply channel portions and each of the plurality of branch liquid-supply channel portions is connected to a corresponding liquid-supply reception port of the plurality of liquid ejecting heads.

4. The liquid supplying apparatus according to claim 1, the at least one liquid container comprises a plurality of liquid containers, and the liquid-supply channels are connected to the plurality of liquid containers.

5. The liquid supplying apparatus according to claim 1, liquid-supply channels are connected to the at least one liquid container directly.

6. The liquid supplying apparatus according to claim 1, liquid-supply channels are connected to the at least one liquid container indirectly.

7. The liquid supplying apparatus according to claim 1, wherein the at least one liquid container has an anisotropic shape and the plurality of liquid-supply channels connect to a longer side of the at least one liquid container.

8. The liquid supplying apparatus according to claim 7, wherein the longer side of the at least one liquid container is substantially parallel to the array direction of the liquid-supply reception ports of the plurality of liquid ejecting heads.

9. The liquid supplying apparatus according to claim 2, wherein the plurality of liquid-supply channels have the same length.

10. A liquid ejecting apparatus comprising:
a plurality of liquid ejecting heads; and
the liquid supplying apparatus according to claim 1 capable of supplying liquid to each of the liquid-supply reception ports of the plurality of liquid ejecting heads.

11. A liquid supplying method for supplying liquid from at least one liquid container capable of containing liquid to a plurality of liquid ejecting heads, the liquid supplying method comprising:
providing a plurality of liquid-supply channels that supplies liquid from the least one liquid container to the plurality of liquid ejecting heads by utilizing the difference in the water head between the at least one liquid container and plurality of liquid ejecting heads; and
connecting the one end of the plurality of liquid-supply channels to the at least one liquid container and the other end to a corresponding liquid-supply reception ports of the plurality of liquid ejecting heads, wherein the number of the liquid-supply reception ports of the liquid ejecting heads is larger than the number of the liquid-supply channels in order to supplying liquid from the at least one liquid container to each of the liquid-supply reception ports of the plurality of liquid ejecting heads through the plurality of liquid-supply channels.

12. A liquid ejecting apparatus comprising:
a plurality of liquid ejecting heads;
a liquid container capable of containing liquid; and
a liquid ejecting apparatus for supplying liquid to the plurality of liquid ejecting heads comprising a plurality of liquid-supply channels which are connected to the at least one liquid container which are further capable of supplying liquid from the at least one liquid container to the plurality of liquid ejecting heads by utilizing a difference in the water head between the liquid container and plurality of liquid ejecting head, wherein each of the plurality of liquid-supply channels are connected to a plurality of corresponding liquid-supply reception ports of the plurality of liquid ejecting heads and the number of the liquid-supply reception ports of the liquid ejecting heads is larger than the number of the liquid-supply channels,
wherein some of the plurality of liquid-supply channels branch into a plurality of branch liquid-supply channel portions which are connected to the corresponding liquid-supply reception ports of the plurality of liquid ejecting heads.

13. A liquid ejecting apparatus according to claim 12, wherein each of the plurality of liquid-supply channels branches into a plurality of branch liquid-supply channel portions and each of the plurality of branch liquid-supply channel portions is connected to a corresponding liquid-supply reception port of the plurality of liquid ejecting heads.

14. A liquid ejecting apparatus according to claim 12, the at least one liquid container comprises a plurality of liquid containers, and the liquid-supply channels are connected to the plurality of liquid containers.

15. A liquid ejecting apparatus according to claim 12, liquid-supply channels are connected to the at least one liquid container directly.

16. A liquid ejecting apparatus according to claim 12, liquid-supply channels are connected to the at least one liquid container indirectly.

17. A liquid ejecting apparatus according to claim 12, wherein the at least one liquid container has an anisotropic shape and the plurality of liquid-supply channels connect to a longer side of the at least one liquid container.

18. A liquid ejecting apparatus according to claim 17, wherein the longer side of the at least one liquid container is substantially parallel to the array direction of the liquid-supply reception ports of the plurality of liquid ejecting heads.

19. A liquid ejecting apparatus according to claim 12, wherein the plurality of liquid-supply channels have the same length.
